(19) United States
(12) Patent Application Publication
(10) Pub. No.: US 2016/0014705 A1
(43) Pub. Date: Jan. 14, 2016

(54) RELAY CONTROL STATION, REPEATER, AND INTERFERENCE SUPPRESSING METHOD

(71) Applicant: MITSUBISHI ELECTRIC CORPORATION, Chiyoda-ku, Tokyo (JP)

(72) Inventors: Shigenori TANI, Tokyo (JP); Katsuyuki MOTOYOSHI, Tokyo (JP); Akinori FUJIMURA, Tokyo (JP)

(73) Assignee: Mitsubishi Electric Corporation, Chiyoda-ku, Tokyo (JP)

(21) Appl. No.: 14/650,788

(22) PCT Filed: Nov. 22, 2013
(86) PCT No.: PCT/JP13/81514

§ 371 Date: Jun. 9, 2015

(30) Foreign Application Priority Data
Feb. 21, 2013 (JP) 2013-032222

(51) Int. Cl. H04W 52/46; H04W 72/04; H04W 24/08; H04W 52/52; H04W 72/08

(52) U.S. Cl. CPC H04W 52/46; H04W 52/52; H04W 72/082; H04W 24/08; H04W 72/046; H04B 2001/0416

(57) ABSTRACT

A relay control station includes a power control unit that determines, on the basis of a power value of each of demultiplexed signals measured by the repeater and an expected power value of each of the demultiplexed signals, a gain control amount provisional value for each of the demodulated signals and calculates a gain control value of each of the demultiplexed signals for the repeater on the basis of a ratio between a sum of power estimation values of all the demultiplexed signals obtained when the gain control amount provisional value is applied and a sum of power values of all the demultiplexed signals measured by the repeater and the gain control amount provisional value; and a repeater interface unit that notifies the repeater of the gain control amount calculated by the power control unit.

### FIELD

The present invention relates to a relay control station, a repeater, and an interference suppressing method of a satellite communication system.

### BACKGROUND

A satellite communication system is introduced that performs communication between two points of the ground and a ship, an airplane, or the like on the earth using an artificial satellite or the like operating in earth orbit in the outer space. In such a system, a repeater mounted on the artificial satellite receives a signal transmitted from a communication apparatus on the earth and transmits (relays) the signal to another communication apparatus on the earth to realize the communication between the two points.

In recent years, according to the increase in the capacity of a satellite communication system, multi-beam data transmission of performing data transmission with a different beam for each region has been examined. When the multi-beam data transmission is realized by a through-repeater satellite by the conventional analog frequency conversion, frequencies necessary for uplink (from a ground station to a satellite) data transmission need to be secured by the number of beams.

Therefore, to effectively use limited frequencies, a channelizer technology has been examined that can greatly reduce, in a satellite, an uplink required signal bandwidth by, after demultiplexing received signals into minimum frequency units, allocating the demultiplexed signals to beams of transmission destinations and multiplexing the allocated signals.

According to the diversification of the satellite communication system, it is assumed that transceivers having a plurality of different antenna diameters relay signals via a repeater. Moreover, it is assumed that the repeater relays signals at different transmission rates generated in bursts such as sound and moving images.

Specifically, Patent Literature 1 described below discloses a technology for, in the channelizer described above, appropriately controlling gains of signals to effectively use transmission power of a repeater while satisfying the required quality for each line.

Non Patent Literature 1 described below discloses a technology for improving deterioration in signal quality due to inter-modulation distortion of a transmission amplifier mounted on a repeater using the gain control described above.

### CITATION LIST

### Patent Literature

Patent Literature 1: United States Patent Application Publication No. 2004/0071236

### Non Patent Literature

Non Patent Literature 1: John J. Knab (Defense Information Systems Agency) “Transponder Power Minimization Utilizing Optimum Channelizer Gains” IEEE Transactions on Aerospace and electronic systems, Vol. 48, No 1 Jan. 2012.

### SUMMARY

### Technical Problem

According to the widening of the band of a satellite communication system and the expansion of a service area, a repeater is likely to receive an unintended signal due to interference from another system, a failure of a transmitter, or the like besides a signal transmitted from a transmission station. However, in the conventional technology (Patent Literature 1), because the gain is controlled for each band of a signal transmitted by the transmitter, when an interference wave in a band narrower than a signal band is received, it is difficult to suppress only a demultiplexed signal including the interference wave. Therefore, there is a problem in that the transmission power of the repeater cannot be effectively utilized because an unnecessary interference wave is relayed.

The present invention has been devised in view of the above and it is an object of the present invention to obtain a relay control station, a repeater, and an interference suppressing method capable of effectively utilizing the transmission power of the repeater while improving the reception quality of a receiver.

### Solution to Problem

In order to solve the above problems and achieve the object, an aspect of the present invention is a relay control station that controls a repeater in a communication system in which a transmitter transmits data to a receiver serving any beam via the repeater including one or more beams, the relay control station including: a power control unit that determines, on a basis of a power value of each of demultiplexed signals measured by the repeater and an expected power value of each of the demultiplexed signals, a gain control amount provisional value for each of the demodulated signals and calculates a gain control value of each of the demultiplexed signals for the repeater on a basis of a ratio between a sum of power estimation values of all the demultiplexed signals obtained when the gain control amount provisional value is applied and a sum of power values of all the demultiplexed signals measured by the repeater and the gain control amount provisional value; and a repeater interface unit that notifies the repeater of the gain control amount calculated by the power control unit.

### Advantageous Effects of Invention

The relay control station, the repeater, and the interference suppressing method according to the present invention attain an effect that it is possible to effectively utilize the transmission power of the repeater while improving the reception quality of a receiver.

### BRIEF DESCRIPTION OF DRAWINGS

FIG. 1 is a diagram showing a configuration example of a satellite communication system in a first embodiment.

FIG. 2 is a diagram showing a configuration example of a repeater in the first embodiment.

FIG. 3 is a diagram showing a configuration example of a control station in the first embodiment.

FIG. 4 is a diagram showing electric powers of signals in a gain control unit in the first embodiment.

FIG. 5 is a diagram showing a state in which inter-modulation distortion occurs.

FIG. 6 is a diagram showing electric powers of signals in a gain control unit in a second embodiment.

FIG. 7 is a diagram showing a configuration example of a repeater in the second embodiment.

### DESCRIPTION OF EMBODIMENTS

Exemplary embodiments of a relay control station, a repeater, and an interference suppressing method according to the present invention are explained in detail below with reference to the drawings. Note that the present invention is not limited by the embodiments.

### First Embodiment

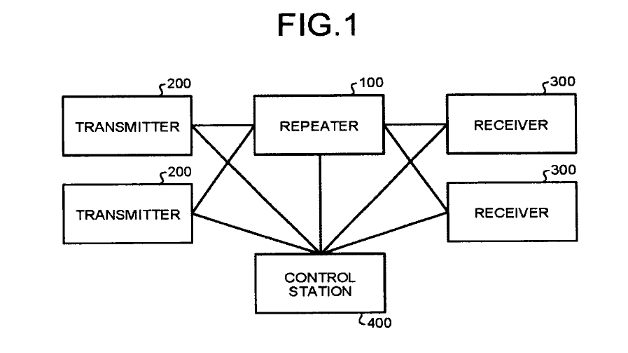

FIG. 1 is a diagram showing a configuration example of a satellite communication system in the present embodiment. The satellite communication system is configured from a repeater 100, transmitters 200, receivers 300, and a control station 400. The repeater 100 is connected to the transmitters 200, the receivers 300, and the control station 400, the transmitters 200 are connected to the repeater 100 and the control station 400, the receivers 300 are connected to the repeater 100 and the control station 400, and the control station 400 is connected to the repeater 100, the transmitters 200, and the receivers 300 by radio. Note that, in FIG. 1, two transmitters 200 and two receivers 300 are connected. However, this is an example. The number of the connected transmitters and receivers is not limited to two.

The configurations of the repeater 100 and the control station 400 configuring the satellite communication system are explained. Note that the transmitters 200 and the receivers 300 are not characteristics in the present invention and can have conventionally used configurations; therefore, detailed explanation of their configurations is omitted.

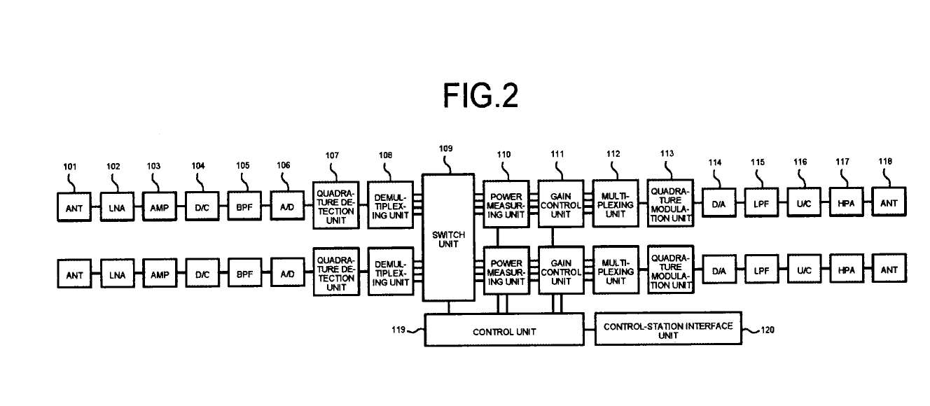

FIG. 2 is a diagram showing a configuration example of the repeater 100 in the present embodiment. The repeater 100 includes reception antennas (ANT) 101, low-noise amplifiers (LNA) 102, variable amplifiers (AMP) 103, down-converters (D/C) 104, band-pass filters (BPF) 105, analog-digital converters (A/D) 106, quadrature detection units 107, demultiplexing units 108, a switch unit 109, power measuring units 110, gain control units 111, multiplexing units 112, quadrature modulation units 113, digital-analog converters (D/A) 114, low-pass filters (LPF) 115, up-converters (U/C) 116, high-power amplifiers (HPA) 117, transmission antennas (ANT) 118, a control unit 119, and a control-station interface unit 120.

In FIG. 2, the components other than the switch unit 109, the control unit 119, and the control-station interface unit 120 are shown in two systems. This is for a configuration for processing signals included in one beam per system. Note that the configuration shown in FIG. 2 is an example. The number of systems is not limited to two and can be any number according to the number of beams required by the satellite communication system.

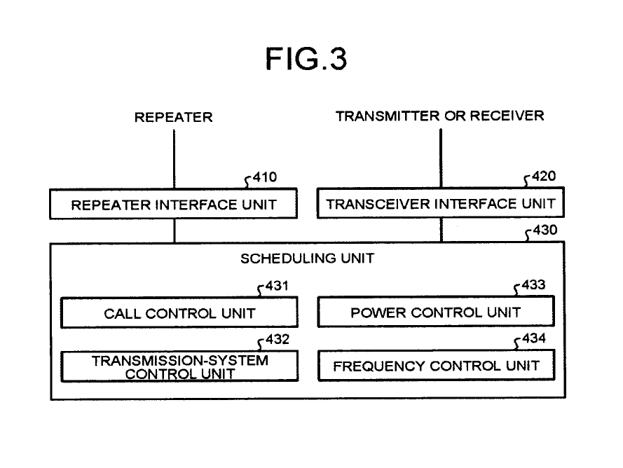

The configuration of the control station 400 is explained. The control station 400 is a relay control station that controls the gain and the like in the gain control unit 111 of the repeater 100 in the satellite communication system. FIG. 3 is a diagram showing a configuration example of the control station 400 in the present embodiment. The control station 400 includes a repeater interface unit 410, a transceiver interface unit 420, and a scheduling unit 430. The scheduling unit 430 includes a call control unit 431, a transmission-system control unit 432, a power control unit 433, and a frequency control unit 434.

The operations of the devices performed when the transmitter 200 transmits data to the receiver 300 via the repeater 100 and a control method of the control station 400 for controlling the repeater 100 in the satellite communication system shown in FIG. 1 are explained.

First, the transmitter 200 encodes and modulates data to be transmitted and transmits the data to the repeater 100. As a communication system between the transmitter 200 and the repeater 100, any system can be used. If a communication system is determined in advance between the transmitter 200 and the receiver 300, the receiver 300 can demodulate and decode a signal. The frequency at which the transmitter 200 transmits a signal conforms to the frequency position notified in advance from the control station 400 explained below.

In the repeater 100, the reception antenna 101 receives a signal from the transmitter 200 and the low-noise amplifier 102 amplifies the signal. Thereafter, the variable amplifier 103 adjusts the level such that the signal power output to the post stage is constant. After the down-converter 104 converts the carrier frequency into an intermediate frequency, the band-pass filter 105 suppresses a high-frequency component. The analog-digital converter 106 converts the analog signal into a digital signal. The quadrature detection unit 107 converts the signal having the intermediate frequency into a baseband signal. The demultiplexing unit. 108 demultiplexes the baseband signal into M number of signals. For example, when a signal having a frequency bandwidth of 10 MHz is demultiplexed into signals having a frequency bandwidth of 1 MHz, ten demultiplexed signals are generated (M=10).

The switch unit 109 selects routes of the demultiplexed signals according to the route information designated from the control unit 119 explained below and outputs the signals to the power measuring unit 110. For example, in FIG. 2, two systems from the reception antenna 101 to the analog-digital converter 106 and from the power measuring unit 110 to the transmission antenna 118 are shown. When the systems are respectively represented as a system A and a system B, the system A receives a signal from a beam that covers the region A as a coverage area and the system B receives a signal from a beam that covers the region B as a coverage area. When a signal of a part of the region A is relayed to the region B, the switch unit 109 outputs a part of the signals demultiplexed in the system A to the power measuring unit of the system B according to the route information to thereby realize relay among a plurality of different beams.

The power measuring unit. 110 measures electric power of the (M number of) demultiplexed signals output from the switch unit 109.

As measures taken when an uplink interference wave is strong and the analog-digital converter 106 is saturated, an AGO (Automatic Gain Control) can be provided at a pre-stage of the analog-digital converter 106. In this case, actually received signal power can be accurately measured by adding the control amount of the AGC and the measurement value of the power measuring unit 110.

The gain control unit 111 changes the amplitude of the demultiplexed signals according to the gain control amount notified from the control unit 119 explained below. The multiplexing unit 112 multiplexes the M number of demultiplexed signals. After the quadrature modulation unit 113 converts the baseband signal into the intermediate frequency, the digital-analog converter 114 converts the digital signal into an analog signal. The low-pass filter 115 suppresses a high-frequency component. After the up-converter 116 converters the intermediate frequency into the carrier frequency, the high-power amplifier 117 amplifies the signal. The transmission antenna 118 then transmits the signal to the receiver 300.

The control unit 119 retains the power value measured by the power measuring unit 110 and the control information (abnormality detection information, etc.) generated by the components of the repeater 100 and notifies the control station 400 of the power value and the control information via the control-station interface unit 120. The control-station interface unit 120 receives the control information (the gain control amount, the route information, etc. explained above) transmitted from the control station 400 and the control unit 119 sets the control information in the components.

The receiver 300 demodulates and decodes the signal received from the repeater 100 and obtains the data. Note that, if the communication system is determined in advance between the receiver 300 and the transmitter 200, the data can be correctly restored.

The control station 400 performs transmission and reception of control information between the repeater interface unit 410 and the repeater 100. The transceiver interface unit 420 performs transmission and reception of the control information with the transmitter 200 or the receiver 300. The control information is control information used or generated by the scheduling unit 430 explained below. The scheduling unit 430 generates control information related to communication of the repeater 100, the transmitter 200, and the receiver 300. Specific control content is explained in explanation of the components.

In the scheduling unit 430, the call control unit 431 instructs, according to a transmission request received from the transmitter 200, the transmission-system control unit 432, the power control unit 433, and the frequency control unit 434 explained below to generate control information required for communication establishment. Note that the call control unit 431 can reject the transmission request when the frequency and electric power that the repeater 100 can relay exceed allowable values. When priority information is included in the transmission request or when priority is determined in advance for the transmitter 200 that has transmitted the transmission request, the call control unit 431 can perform outgoing/incoming call control conforming to the priority.

The transmission-system control unit 432 determines, according to the transmission request, a transmission system necessary for the communication establishment. The transmission system indicates, for example, the modulation system and the coding ratio of error correction. The transmission-system control unit 432 can determine a necessary transmission system from, for example, the diameter of antennas mounted on the transmitter 200 and the receiver 300 and the error rate of a requested signal. Further, when the reception quality is deteriorated during the communication establishment because of rain attenuation or an interference wave from another system, the transmission-system control unit 432 can dynamically change the transmission system by periodically receiving notification of the reception quality (e.g., the signal-to-interference-plus-noise ratio and the demodulation/decoding result) from the receiver 300.

The power control unit 433 determines, according to the transmission request, the transmission power of the transmitter 200 necessary for the communication establishment and the gain control amount changed by the gain control unit 111. The power control unit 433 notifies the gain control unit 111 of the repeater 100 of the determined gain control amount via the repeater interface unit 410.

Note that, in the repeater 100, the gain control amount is notified to the gain control unit 111 via the control-station interface unit 120 and the control unit 119. When information is transmitted and received between the components in the scheduling unit 430 of the control station 400 and the components in the repeater 100, specifically, communication is performed via the repeater interface unit 410 of the control station 400 and the control-station interface unit 120 and the control unit 119 of the repeater 100. However, the communication is omitted in the following explanation.

The frequency control unit 434 allocates, according to the transmission request, unallocated frequencies to the transmitter 200 and the receiver 300, notifies the transmitter 200 and the receiver 300 of the frequency allocation information, and notifies the switch unit 109 of the repeater 100 of the route information via the repeater interface unit 410. Note that, when priority information is included in the transmission request or priority is determined in advance for the transmitter 200 that has transmitted the transmission request, the frequency control unit 434 can perform frequency allocation control conforming to the frequency. The frequency control unit 434 can reduce the frequency allocation bandwidth of the transmitter 200 to which a frequency is already allocated and which has priority lower than the priority of the transmitter 200 that has transmitted the transmission request and preferentially allocate a frequency to the transmitter 200 having a higher priority.

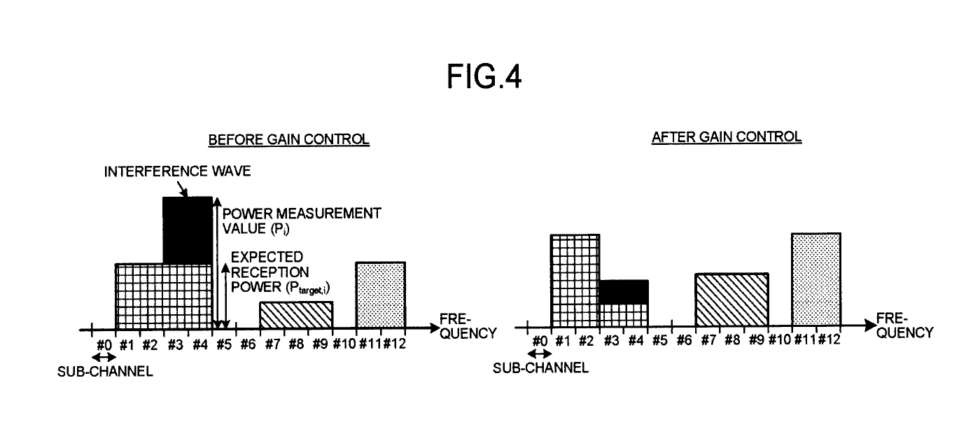

A method of determining a gain control amount for the gain control unit 111 of the repeater 100 in the power control unit 433, which is a characteristic of the present embodiment, is explained with reference to FIG. 4. FIG. 4 is diagram showing electric powers of signals in the gain control unit 111 in the present embodiment. A sub-channel shown in FIG. 4 means a band that the demultiplexing unit 108 demultiplexes. In FIG. 4, signals indicated by sub-channels #1 to #4, #7 to #9, and #11 to #12 are relay target signals. An interference wave is added to sub-channels #3 to #4. When gain control is not performed, because the interference wave is directly relayed to the receiver 300, the reception quality in the receiver 300 is deteriorated. In addition, because a part of the electric power required by the repeater 100 for transmission is wasted by the interference wave, the transmission power cannot be effectively utilized. Therefore, the power control unit 433 determines, on the basis of the power values of the demultiplexed signals (sub-channels) measured by the power measuring unit 110, a gain control amount according to a method (a procedure) explained blow.

Procedure (1) The power control unit 433 calculates a gain Gₐᵢ, which is a provisional value of a gain control amount, from the reception power and the expected reception power of an i-th sub-channel.

Procedure (2) The power control unit 433 calculates a gain G_{bi} for redistributing surplus electric power due to the gain control value in the procedure (1) to all the sub-channels.

The gain Gₐᵢ calculated in the procedure (1) is calculated as indicated by the following Formula (1).

$${G}_{ai} = α {\{ \frac{{P}_{target , 1}}{{p}_{i}} \}}^{β} \qquad ( 1 )$$

In Formula (1), α represents an adjustment coefficient, which is determined according to the priority or the like of the transmitter 200. P_{target} represents expected reception power (an expected power value) in the i-th sub-channel. The expected reception power P_{target} can be estimated by notifying the control station 400 of the power value measured when the power measuring unit 110 does not receive interference. Alternatively, the expected reception power P_{target} can be estimated from the transmission power of the transmitter 200 selected by the power control unit 433, the antenna gain calculated from the antenna diameter, the free space loss, and the like. Pᵢ represents a power measurement value (a power value) in the i-th sub-channel. The power control unit 433 only has to acquire the result measured by the power measuring unit 110 as explained above. β represents an adjustment coefficient different from α. As β is set to a larger value, a gain of the sub-channels including the interference wave decreases and the interference suppression effect increases. However, the signal power included in the i-th sub-channel is attenuated simultaneously with the interference wave. Therefore, β is adjusted to a value that can be demodulated in the receiver 300.

Note that the adjustment coefficients α and β can be changed by the interference suppression performance of the receiver 300. For example, when the receiver 300 has a function of subjecting a reception signal to FFT (Fast Fourier Transform) and suppressing the interference wave at frequency granularity finer than a sub-channel unit or equalizing the interference wave with another system, the adjustment coefficients α and β can be adjustment coefficients that do not reduce a signal transmitted by the transmitter 200.

The gain G_{bi} calculated in the procedure (2) is calculated as indicated by the following Formula (2).

$${G}_{bi} = γ \frac{{\sum }_{k = 0}^{K} {P}_{k}}{{\sum }_{k = 0}^{K} {G}_{ak} {P}_{k}} {G}_{ai} \qquad ( 2 )$$

In Formula (2), γ represents an adjustment coefficient. If γ=1, the sum of the signal powers of the sub-channels is equal before the gain control and after the gain control. On the other hand, when it is desired to dynamically change the coverage area of a beam emitted to any region, the change can be realized by adjusting γ. K represents the number of sub-channels including signals. In the case of FIG. 4, K=9. The denominator represents electric power of all the sub-channels obtained when the gain calculated in the procedure (1) is used. The numerator represents electric power of all the sub-channels obtained before the gain control is performed. Therefore, by setting the gain as indicated by Formula (2), the power control unit 433 can reduce the signal power of the sub-channels including the interference wave while keeping the entire electric power constant and allocate surplus electric power to the other sub-channels.

Note that, when the gain G_{bi} is applied in the repeater 100, in the receiver 300, it is likely that the reception signal power suddenly fluctuates and a continuous error due to divergence and out-of-synchronization of AGC (Automatic Gain Control) occurs. Therefore, when changing the value of the gain G_{bi}, the power control unit 433 can control the repeater interface unit 410, cause the gain control unit 111 to increase or reduce the gain at any step width, and notify, from the repeater interface unit 410, the repeater 100 to bring the gain G_{bi} close to the gain after the change. For example, when the gain is increased by 3 decibels, if any step width (specified value) is 1 decibel, it is possible to relax the power fluctuation due to the gain control by notifying the repeater 100 to dividedly increase the gain three times by 1 decibel at a time.

Note that, in the present embodiment, the power control unit 433 of the control station 400 calculates the gain control amount for the repeater 100 and notifies the repeater 100 of the gain control amount. However, a part or all of the functions of the power control unit 433 can be incorporated in the repeater 100. Consequently, time required for communication of the control information between the control station 400 and the repeater 100 is reduced. Therefore, it is possible to quickly cope with appearance/disappearance of the interference wave.

As explained above, in the present embodiment, in a process in which the transmitter transmits data to the receiver via the repeater, the repeater measures the electric powers of demultiplexed signals. In the control station that controls the gain and the like of the repeater, the power control unit acquires the power measurement values for the demultiplexed signals measured by the repeater, estimates an interference amount in an uplink (transmission from the transmitter to the repeater) from the power measurement values, and controls, on the basis of the reception powers and the expected reception powers of the demultiplexed signals, the gains of the demultiplexed signals to suppress the interference wave. Consequently, when the interference wave is included in any demultiplexed signal, it is possible to reduce the gain of the demultiplexed signal, suppress, in the repeater, the interference wave received in the uplink, and relay the demultiplexed signal. Therefore, it is possible to improve the reception quality of a signal in the receiver. The transmission power of the repeater required when relaying the interference wave, that is, surplus electric power obtained by a gain reduction can be redistributed to the other signals. Therefore, it is possible to effectively utilize the transmission power of the repeater.

### Second Embodiment

In the first embodiment, the gain is controlled such that the influence due to the interference wave of the uplink and the rain attenuation is reduced. However, inter-modulation distortion that occurs in the high-power amplifier 117 of the repeater 100 shown in FIG. 2 is not taken into account.

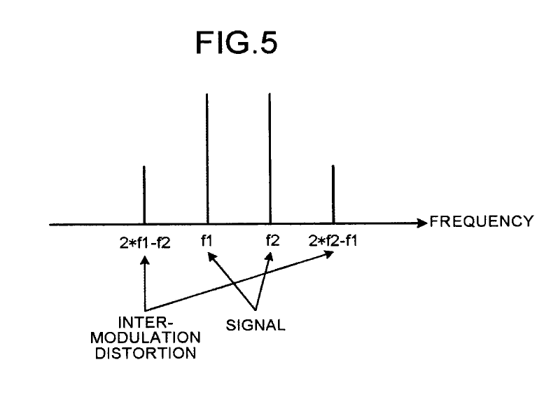

The inter-modulation distortion in the high-power amplifier 117 is explained with reference to FIG. 5. FIG. 5 is a diagram showing a state in which the inter-modulation distortion occurs. In the high-power amplifier 117, when linearity is not kept, a waveform of an output signal is deformed with respect to an input signal; therefore, a harmonic component separate from the frequency of a transmission signal occurs. When a signal is transmitted using a frequency f1 and a frequency f2 as shown in FIG. 5, the inter-modulation distortion occurs in a frequency (2×f1−f2) and a frequency (2×f2−f1). If the repeater 100 transmits another signal using the frequencies in which the inter-modulation distortion occurs, a problem occurs in that reception quality in the receiver 300 is deteriorated by the inter-modulation distortion. In particular, when signals in different communication systems and at different transmission rates are relayed using the same repeater, signals having a power difference of approximately several ten decibels are sometimes arranged at adjacent frequencies. Therefore, the deterioration in the reception quality due to the inter-modulation distortion cannot be ignored in a satellite communication system.

Therefore, in the present embodiment, a method of improving the reception quality of signals in the receiver 300 even when the inter-modulation distortion occurs in the high-power amplifier 117 is explained.

The configurations of the satellite communication system, the repeater 100, and the control station 400 in the present embodiment are the same as the configurations in the first embodiment. Therefore, explanation of the configurations is omitted. Note that, in the present embodiment, a method of determining a gain control amount notified by the control station 400 to the repeater 100 shown in FIG. 1 is different from the method in the first embodiment. Therefore, in the following explanation, only the difference is explained.

When receiving the power measurement values of the demultiplexed signals from the power measuring unit 110, the power control unit 433 detects the power differences among adjacent demultiplexed signals, increases the gain in order from a demultiplexed signal having the largest power difference (a demultiplexed signal having the smallest electric power with respect to an adjacent demultiplexed signal), and calculates a gain control amount to stop the gain increase at a point when the electric power is equal to the electric power of the adjacent demultiplexed signal. However, the power control unit 433 controls the gain of the demultiplexed signal such that the total transmission power after the gain increase does not exceed the maximum transmission power of the repeater 100.

Note that, when a communication system is different from a communication system of the adjacent demultiplexed signal, the power control unit 433 can provide an offset in a target power difference between the demultiplexed signal and the adjacent demultiplexed signal. For example, when there is a difference of N dB in a required signal-to-interference-plus-noise ratio with respect to a target error rate, the power control unit 433 calculates a gain control amount with which the target power difference satisfies N dB.

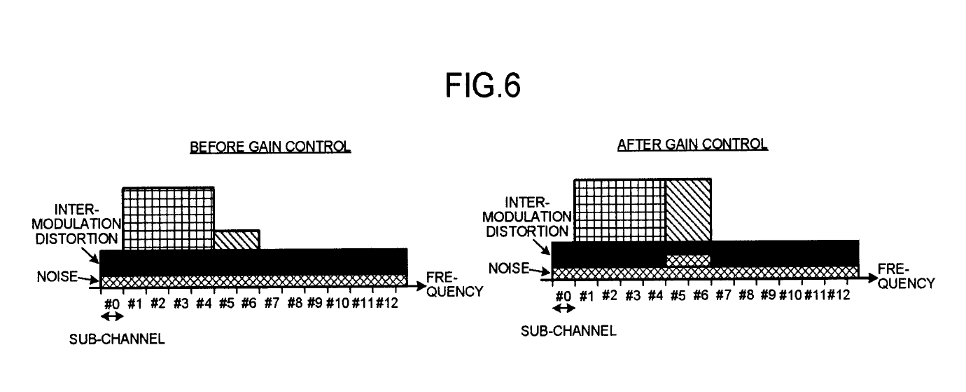

The method of determining a gain control amount in the present embodiment explained above is explained with reference to FIG. 6. FIG. 6 is a diagram showing electric powers of signals in the gain control unit 111 in the present embodiment. In a state before gain control, the signals are transmitted using sub-channels #1 to #4 and #5 to #6. In this case, inter-modulation distortion is caused by two signals. However, in FIG. 6, for simplification, it is assumed that the inter-modulation distortion is caused by behavior same as noise in an entire band. The power control unit 433 can control deterioration in reception quality due to the inter-modulation distortion by increasing the gain control amount of the sub-channels #5 to #6 to set the signal power thereof to be equal to the signal power of the sub-channel #4. Note that noise that occurs at a pre-stage of the gain control unit 111 is also emphasized by the increase in the gain. However, the signal-to-noise ratio excluding the inter-modulation distortion does not change.

Note that, in FIG. 6, the frequency characteristic of the inter-modulation distortion is not taken into account. However, actually, as explained above, the inter-modulation distortion occurs in a specific frequency. Therefore, the power control unit 433 estimates, from the power measurement values of the demultiplexed signals, the frequency at which the inter-modulation distortion occurs and notifies the frequency control unit 434 to avoid transmission at the frequency. The frequency control unit 434 can notify, concerning the frequency at which an estimated value of the inter-modulation distortion is smaller than a predetermined value, the transmitter 200 of a change in a transmission frequency and notify the switch unit 109 of a change of route information.

In some case, even if the gain control described above is performed, the target reception quality is not satisfied in the receiver 300 because of a specific apparatus failure of the repeater 100 and an unintended interference wave of a downlink. Therefore, the receiver 300 can periodically report the reception quality to the control station 400. The power control unit. 433 can adjust the gain according to the difference between the reception quality and the target reception quality.

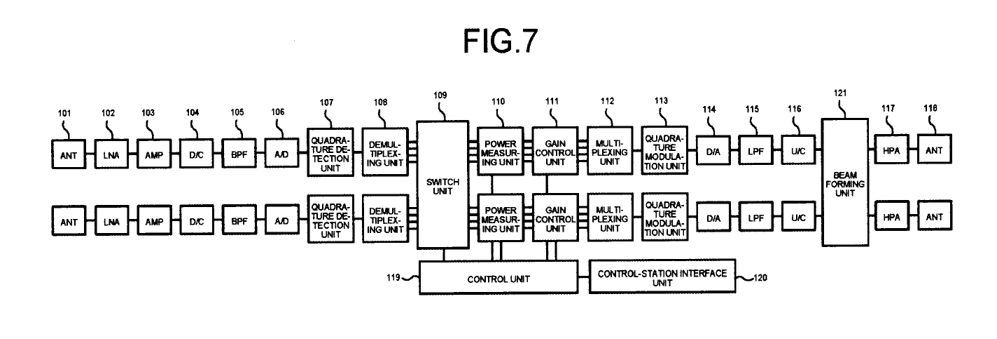

When a beam forming unit 121 is mounted at a post stage of the up-converter 116 as shown in FIG. 7, the beam forming unit 121 controls the phase and the amplitude of signals received from one or more up-converters 116. The signals are transmitted using the transmission antennas 118 of a phased array antenna type. FIG. 7 is a diagram showing a configuration example of the repeater 100 in the present embodiment. Signals of all the systems input to the beam forming unit 121 are combined and input to the high-power amplifier 117. Therefore, the power control unit 433 can perform the gain control described above according to the sum of electric powers of all the systems of the same sub-channel.

As in the first embodiment, when the gain control is changed, the power control unit 433 can cause the gain control unit 111 to increase or reduce the gain at any step width and notify the repeater 100 to bring the gain closer to the gain after the change.

As in the first embodiment, a part or all of the functions of the power control unit 433 and the frequency control unit 434 can be incorporated in the repeater 100. Consequently, time required for communication of the control information between the control station 400 and the repeater 100 is reduced. Therefore, it is possible to quickly cope with appearance/disappearance of the interference wave.

As explained above, in the present embodiment, in a process in which the transmitter transmits data to the receiver via the repeater, the control station, which controls the gain and the like of the repeater, estimates an interference amount due to the inter-modulation distortion from the power measurement values for the demultiplexed signals measured by the repeater and controls the gains of the demultiplexed signals such that deterioration in reception quality caused from the interference amount is minimized, specifically, calculates the power differences among adjacent demultiplexed signals, and increases the gain in order from a demultiplexed signal having the largest power difference (a demultiplexed signal having the smallest electric power with respect to an adjacent demultiplexed signal). Consequently, it is possible to suppress deterioration in the reception quality in the receiver due to the inter-modulation distortion that fluctuates every moment. Because excessive gain setting can be avoided, it is possible to effectively utilize the transmission power of the repeater.

### Third Embodiment

In the first embodiment, the gain is controlled such that the influence due to the interference wave in the uplink and the rain attenuation is reduced. In the second embodiment, the gain is controlled such that the influence of the inter-modulation distortion in the high-power amplifier 117 is reduced.

The gain control amount calculated in the first embodiment and the gain control amount calculated in the second embodiment do not always coincide with each other. The performances of the high-power amplifiers 117 mounted on the repeater 100 are different from each other. On the other hand, the gain control amount notified to the repeater 100 is one kind per demultiplexed signal.

Therefore, in the present embodiment, a method of setting, in the repeater 100, gain control amounts calculated according to different indexes is explained.

The configurations of a satellite communication system, the repeater 100, and the control station 400 in the present embodiment are the same as the configurations in the first and second embodiments. Therefore, explanation of the configurations is omitted. Note that, in the present embodiment, a method of determining a gain control amount notified by the control station 400 to the repeater 100 shown in FIG. 1 is different from the methods in the first and second embodiments. Therefore, in the following explanation, only the difference is explained.

When the gain control amount calculated in the first embodiment is represented as G₁ᵢ and the gain control amount calculated in the second embodiment is represented as G₂ᵢ, in the present embodiment, as indicated by Formula (3), the power control unit 433 calculates a gain control amount G₃ᵢ by multiplying the respective gain control amounts by any coefficients for weighting.

$${G}_{3 i} = \frac{1}{2} ( {a}_{1} {G}_{1 i} + {a}_{2} {G}_{2 i} ) \qquad ( 3 )$$

With the above definition, for example, when an amplifier having a high inter-modulation distortion performance is used, the power control unit 433 only has to set a coefficient a₂ multiplied by the gain control amount G_{2i to} 0. Other indexes can be combined. As a more general expression, a gain control amount can be determined as indicated by Formula (4).

$${G}_{3 i} = \frac{1}{N} {\sum }_{n = 1}^{N} {a}_{n} {G}_{ni} \qquad ( 4 )$$

As explained above, in the present embodiment, the gain control value obtained according to the different indexes are weighted to calculate one gain control amount. Consequently, it is possible to perform control taking into account a plurality of gain control amounts obtained according to the different indexes.

### INDUSTRIAL APPLICABILITY

As explained above, the relay control station, the repeater, and the interference suppressing method according to the present invention are useful for a radio communication system and, in particular, suitable for a system including a repeater that replays signals between a transmitter and a receiver.

### REFERENCE SIGNS LIST

100 repeater, 101 reception antenna, 102 low-noise amplifier, 103 variable amplifier, 104 down-converter, 105 band-pass filter, 106 analog-digital converter, 107 quadrature detection unit, 108 demultiplexing unit, 109 switch unit, 110 power measuring unit, 111 gain control unit, 112 multiplexing unit, 113 quadrature modulation unit, 114 digital-analog converter, 115 low-pass filter, 116 up-converter, 117 high-power amplifier, 118 transmission antenna, 119 control unit, 120 control-station interface unit, 121 beam forming unit, 200 transmitter, 300 receiver, 400 control station, 410 repeater interface unit, 420 transceiver interface unit, 430 scheduling unit, 431 call control unit, 432 transmission-system control unit, 433 power control unit, 434 frequency control unit.

1. A relay control station that controls a repeater in a communication system in which a transmitter transmits data to a receiver serving any beam via the repeater including one or more beams, the relay control station comprising:
a power control unit that determines, on a basis of power values of a plurality of demultiplexed signals measured by the repeater and each expected power value of the demultiplexed signals, a gain control amount provisional value for the demodulated signals and calculates a gain control value of the demultiplexed signals for the repeater on a basis of a ratio between a sum of power estimation values of the demultiplexed signals obtained when the gain control amount provisional value is applied and a sum of the power values of the demultiplexed signals and the gain control amount provisional value, the demultiplexed signals being obtained by the repeater demultiplexing a reception signal received from the transmitter; and
a repeater interface unit that notifies the repeater of the gain control amount calculated by the power control unit as a control amount used for gain control performed on the demultiplexed signals by the repeater.

2. The relay control station according to claim 1, wherein the power control unit sets, as the gain control amount provisional value, a value obtained by raising a ratio between the power value and the expected power value to a power.

3. The relay control station according to claim 1, wherein the power control unit sets, as the gain control amount provisional value, a value obtained by multiplying a ratio between the power value and the expected power value by a coefficient based on priority of the transmitter.

4. The relay control station according to claim 1, wherein the power control unit calculates the gain control amount by further using a coefficient for adjusting a coverage area of the any beam.

5. The relay control station according to claim 1, wherein, when updating the gain control amount, if a difference between a gain control amount after update and a gain control amount before update is larger than a specified value, the power control unit sets a difference between a present gain control amount in the repeater and a gain control amount notified to the repeater to the specified value or less, controls the repeater interface unit, and notifies the repeater of the gain control amount a plurality of times from the repeater interface unit.

6. The relay control station according to claim 1, wherein the power control unit sets, as the gain control amount, an average of a value obtained by multiplying the gain control amount by a first coefficient and a value obtained by multiplying a gain control amount calculated according to another index by a second coefficient.

7. A repeater in a communication system in which a transmitter transmits data to a receiver serving any beam via the repeater including one or more beams, the repeater comprising:
a demultiplexing unit that demultiplexes a reception signal received from the transmitter into a plurality of demultiplexed signals;
a measuring unit that measures power values of the demultiplexed signals;
a power control unit that determines, on a basis of the power values of the demultiplexed signals and expected power values of the demultiplexed signals, a gain control amount provisional value for the demodulated signals and calculates a gain control value of the demultiplexed signals on a basis of a ratio between a sum of power estimation values of the demultiplexed signals obtained when the gain control amount provisional value is applied and a sum of the power values of the demultiplexed signals and the gain control amount provisional value; and
a gain control unit that controls signal power of the demultiplexed signals on a basis of the gain control amount calculated by the power control unit.

8. The repeater according to claim 7, wherein the power control unit sets, as the gain control amount provisional value, a value obtained by raising a ratio between the power value and the expected power value to a power.

9. The repeater according to claim 7, wherein the power control unit sets, as the gain control amount provisional value, a value obtained by multiplying a ratio between the power value and the expected power value by a coefficient based on priority of the transmitter.

10. The repeater according to claim 7, wherein the power control unit calculates the gain control amount by further using a coefficient for adjusting a coverage area of the any beam.

11. The repeater according to claim 7, wherein, when updating the gain control amount, if a difference between a gain control amount after update and a gain control amount before update is larger than a specified value, the power control unit sets a difference between a present gain control amount in the repeater and the gain control amount after update to the specified value or less and updates the gain control amount a plurality of times.

12. The repeater according to claim 7, wherein the power control unit sets, as the gain control amount, an average of a value obtained by multiplying the gain control amount by a first coefficient and a value obtained by multiplying a gain control amount calculated according to another index by a second coefficient.

13. An interference suppressing method of a relay control station that controls a repeater in a communication system in which a transmitter transmits data to a receiver serving any beam via the repeater including one or more beams, the interference suppressing method comprising:
a gain-control-amount-provisional-value determining of determining, on a basis of power values of a plurality of demultiplexed signals measured by the repeater and each expected power value of the demultiplexed signals, a gain control amount provisional value for the demodulated signals, the demultiplexed signals being obtained by the repeater demultiplexing a reception signal received from the transmitter;
a gain-control-amount calculating of calculating a gain control value of the demultiplexed signals for the repeater on a basis of a ratio between a sum of power estimation values of the demultiplexed signals obtained when the gain control amount provisional value is applied and a sum of the power values of the demultiplexed signals and the gain control amount provisional value; and
a gain-control-amount notifying of notifying the repeater of the calculated gain control amount as a control amount used for gain control performed on the demultiplexed signals by the repeater.

14. The interference suppressing method according to claim 13, wherein the gain-control-amount-provisional-value determining includes setting, as the gain control amount provisional value, a value obtained by raising a ratio between the power value and the expected power value to a power.

15. The interference suppressing method according to claim 13, wherein the gain-control-amount-provisional-value determining includes setting, as the gain control amount provisional value, a value obtained by multiplying a ratio between the power value and the expected power value by a coefficient based on priority of the transmitter.

16. The interference suppressing method according to claim 13, wherein the gain-control-amount calculating includes calculating the gain control amount by further using a coefficient for adjusting a coverage area of the any beam.

17. The interference suppressing method according to claim 13, wherein, when updating the gain control amount, if a difference between a gain control amount after update and a gain control amount before update is larger than a specified value, the gain-control-amount notifying includes setting a difference between a present gain control amount in the repeater and a gain control amount notified to the repeater to the specified value or less and notifying the repeater of the gain control amount a plurality of times.

18. The interference suppressing method according to claim 13, wherein the gain-control-amount calculating includes setting, as the gain control amount, an average of a value obtained by multiplying the gain control amount by a first coefficient and a value obtained by multiplying a gain control amount calculated according to another index by a second coefficient.
